(19) United States
(12) Patent Application Publication
(10) Pub. No.: US 2004/0040807 A1
(43) Pub. Date: Mar. 4, 2004

(54) Method for operating an electronically controllable brake actuation system, and electronically controlable brake actuation system

(76) Inventors: Jochen Burgdorf, Offenbach (DE); Peter Volz, Darmstadt (DE)

Correspondence Address: RATNERPRESTIA, P O BOX 980, VALLEY FORGE, PA, 19482-0980, US

(21) Appl. No.: 10/432,097

(22) PCT Filed: Nov. 5, 2001
(86) PCT No.: PCT/EP01/12794

(30) Foreign Application Priority Data
Nov. 23, 2000 (DE) 100 58 289.3
Sep. 25, 2001 (DE) 101 47 108.7

(51) Int. Cl. B60T 11/00

(52) U.S. Cl. 188/352

(57) ABSTRACT

The present invention relates to a method for operating an electronically controllable brake actuation system for motor vehicles and a device for implementing the method. The system comprises a non-pressurized pressure fluid supply reservoir, a pressure source actuatable by an electronic control unit, whose pressure can be applied to wheel brakes of the vehicle, a device for detecting a driver's request for deceleration, as well as valve assemblies inserted upstream of the wheel brakes and connecting the wheel brakes optionally to the pressure source or the pressure fluid reservoir.

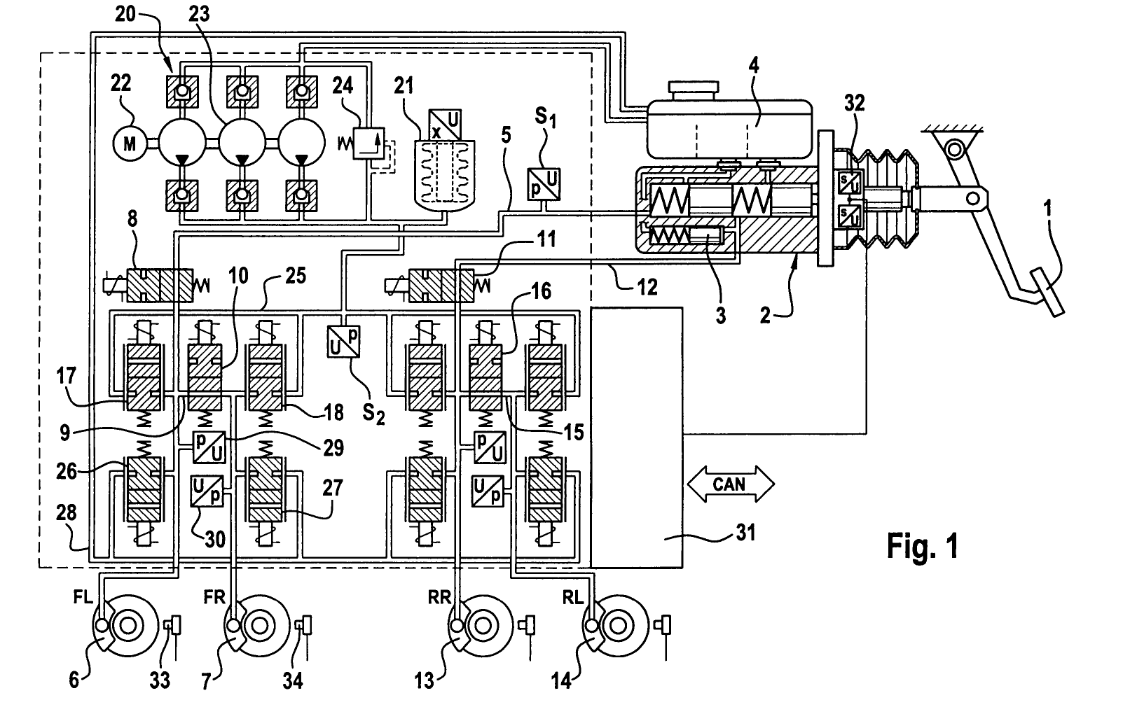

To increase the operational or functional safety of a like system, according to the present invention, an electronically controlled procedure step is provided regarding the removal of contaminants contained and/or dissolved in the brake system, in particular in the pressure fluid. A device for implementing the method is equipped with a means for the electronically controlled removal of contaminants contained and/or dissolved in the brake system, especially in the pressure fluid.

### TECHNICAL FIELD

The present invention relates to a method for operating an electronically controllable brake actuation system for motor vehicles, including a non-pressurized pressure fluid supply reservoir, at least one pressure source actuatable by an electronic control unit, whose pressure can be applied to wheel brakes of the vehicle, a device for detecting a driver's request for deceleration, as well as valve devices inserted upstream of the wheel brakes and connecting the wheel brakes optionally to the pressure source or the pressure fluid reservoir.

### BACKGROUND OF THE INVENTION

The technical article ‘Electrohydraulic Brake System—The First Approach to Brake-By-Wire Technology’, SAE Paper 960991, e.g. discloses an electronically controllable brake actuation system.

Because a vehicle operator is decoupled from the generation of brake force in electrohydraulic brake systems (EHB) and the braking request is realized quasi by wire, a set-point generator with simulator is employed that reproduces the pedal feeling achieved on account of actuation in a way comparable to the reaction of a conventional brake system. Further, the set-point generator comprises a master cylinder permitting a hydraulic emergency braking mode in the event of malfunction of the electronics by means of a direct actuation of the wheel brakes (so-called hydraulic fallback mode). As soon as a request for actuation is detected in the by-wire mode because e.g. actuation of a brake pedal is sensed, separating valves are being closed in order to shut off a direct hydraulic through grip of the master cylinder in the direction of the wheel brakes. While brake pressure build-up is initiated in an electrohydraulic fashion, the vehicle operator experiences a reaction force due to displacement of volume into the simulator that corresponds to the actuating movement.

It is of major importance that the hydraulic fallback level is available. Air, which is brought in unnoticedly especially during the by-wire operation, may limit or prevent the function of the hydraulic fallback level because the pressure fluid shows a compressible reaction when the driver builds up pressure. The above-mentioned publication does not allow gathering any provisions, which could eliminate or at least considerably minimize any malfunction that occurs in by-wire brake systems e.g. due to compressibility or other contaminants.

German patent DE 29 37 957 B1 discloses a degassing device that necessitates a vacuum circuit with a vacuum source and is not appropriate for purifying a by-wire brake system.

German patent application DE 197 17 043 A1 discloses a device for dehydrating and/or degassing hydraulic fluids, said device requiring a membrane that is impermeable—semi-permeable to the hydraulic fluid. Gas and/or water are/is separated from the hydraulic fluid through the membrane according to the physical principle of pervaporation. Being a separate, additional component, the membrane entails high costs. Suspended matter remains in the hydraulic fluid with this device.

### BRIEF SUMMARY OF THE INVENTION

An object of the present invention is to improve the availability of the hydraulic fallback level of a by-wire brake system.

This object is basically achieved by the present invention in that an electronically controlled procedure step is provided regarding the removal of contaminants contained and/or dissolved in the brake system, in particular in the pressure fluid. The degree of contamination in the pressure fluid is reduced by the invention so that the function of the brake system is ensured even in a case of failure. Because e.g. air inclusions are removed, seal-tightness requirements placed on the components of the system may be lowered.

A favorable aspect of the present invention arranges for the procedure step to be automated and/or performed on call. This feature renders it possible to execute the removal of contaminants on request or e.g. in a programmed fashion during the stop periods of the vehicle in an automated manner.

In a favorable improvement of the invention, a cleansing routine is provided for removal, effecting a revolution of the pressure fluid so that undesirable contaminants can be removed also from dead pipe line branches, meaning those branches which encounter no or only little fluid circulation during normal operation.

It is feasible in the context of the cleansing routine to control the valve assemblies according to a predefinable chronological order to change from an open position into a closed position and vice-versa, and to initiate pressure fluid supply by means of a pump so that all pipeline branches can be scavenged. The duration of the cleansing routine may be adjusted in dependence on the degree of contamination.

According to a device for implementing the above method, a means is provided for the electronically controlled removal of contaminants contained or dissolved in the brake system, in particular in the pressure fluid. The means effects the removal of contaminants, and more particularly a successive reduction of gases so that the availability of the hydraulic fallback level is ensured even if leakage occurs at any location. When the means for removal is an integral component of the brake actuation system, a simple compact design is thereby achieved because the means is a system component integrated into the pipeline system. The means may be integrated into a pressure fluid reservoir 4 in particular. A further simplified design is provided when an absolutely necessary component part of the brake actuation system is additionally used as a means for removal. In other words, a double function is given so that the costs entailed for the means for removal are extremely low.

To achieve an accelerated removal process, the pressure fluid flow is rated so that line portions with a high flow velocity of the pressure fluid are provided and that following downstream thereof is at least one separating zone with a pressure fluid flow velocity lower in comparison. The alternation between the pressure fluid flow velocities mainly takes place at short notice.

At least one means for heating the pressure fluid is arranged for according to a preferred embodiment of the invention. A so-called baking-out process improves the degassing performance of the pressure fluid.

It is further advantageous for the acceleration of the degassing action that the separating zone is disposed in the range of a pressure drain. For further pressure reduction, pressure below atmospheric pressure or vacuum may be provided in the area of the separating zone (pressure fluid reservoir) in addition.

For further improvement of the removal, a system component, in particular the separating zone may be equipped with an ultrasonic generator to generate ultrasonic vibrations in the pressure fluid.

### BRIEF DESCRIPTION OF THE DRAWINGS

This invention will be explained in detail in the following description of an embodiment by making reference to the accompanying drawing. In the drawing, the only FIGURE shows a schematic wiring diagram of an electrohydraulic brake actuation system adopting a de-energized, so-called hydraulic fallback level.

### DETAILED DESCRIPTION OF THE DRAWINGS

An electronically controllable brake actuation system comprises a dual-circuit master cylinder or tandem master cylinder 2 that is operable by means of an actuating pedal 1, cooperates with a simulator 3 and includes two pressure chambers isolated from one another and being in communication with a non-pressurized pressure fluid reservoir 4. Wheel brakes 6, 7 e.g. associated with the front axle are connected to a first pressure chamber by means of a closable first hydraulic line 5 wherein a pressure sensor S₁ is incorporated. Line 5 is closed by means of a first separating valve 8 for an electrohydraulic normal braking operation, while in a line portion 9 between the wheel brakes 6, 7 an electromagnetically operable, preferably normally open (NO) pressure compensating valve 10 is inserted which, when in its closed condition, enables brake pressure control on each individual wheel.

The second pressure chamber of the master brake cylinder 2 is connectable to a pair of wheel brakes 13, 14 associated with the rear axle by way of a second hydraulic line 12 closable by means of a second separating valve 11. An electromagnetically operable, preferably normally open (NO) pressure compensating valve 16 is inserted into a line portion 15 disposed between the wheel brakes 13, 14. As the design of the hydraulic circuit of the rear axle connected to the second pressure chamber of the master brake cylinder 2 is identical to the front-axle circuit explained in the preceding description, the following description exclusively refers to the front-axle circuit.

As can be taken from the drawing, a motor-and-pump assembly with a high-pressure accumulator 21 is used as a pressure source 20, said assembly in turn comprising a pump 23 driven by means of an electric motor 22 and having preferably a plurality of parallel connected supply devices as well as a pressure limiting valve 24 connected in parallel to said pump 23. The suction side of the pump 23 is connected to the above-mentioned pressure fluid reservoir 4 by way of a non-return valve. A pressure sensor S₂ monitors the hydraulic pressure generated by the pump 23.

A third hydraulic line 25 connects the high-pressure accumulator 21 to inlet ports of two electromagnetic, normally closed two-way/two-position directional control valves 17, 18 of analog operation which are connected upstream of the wheel brakes 6 and 7 in the capacity of inlet valves. Further, the wheel brakes 6, 7 are connected to a fourth hydraulic line 28 by way of each one electromagnetic, normally closed two-way/two-position directional control valve or outlet valve 26, 27 of analog operation, said line 28 being in communication with the non-pressurized pressure fluid reservoir 4, on the other hand. The hydraulic pressure prevailing in the wheel brakes 6, 7 is determined by means of each one pressure sensor 29, 30.

An electronic control unit 31 (ECU) is used for the joint actuation of the motor-and-pump assembly 20 as well as the electromagnetic valves 8, 10, 11, 16, 17, 18, 19, 26, 27. The output signals of an actuating travel sensor 32 cooperating with the actuating pedal 1 and of the above-mentioned pressure sensor S₁ are sent as input signals to said control unit 31, thereby permitting detection of the driver's deceleration demand. However, other means such as a force sensor sensing the actuating force at the actuating pedal 1 may also be used for the detection of the driver's deceleration demand. As further input quantities, the output signals of the pressure sensors 29, 30 as well as the output signals of wheel sensors 33, 34 (only represented) representative of the vehicle speed are sent to the electronic control unit 31.

To remove contaminants disposed in the piping net of the brake system, a cleansing routine of the pressure fluid that is controlled electronically by way of a data processing program is carried out in a separate procedure step. Contaminants such as gases (air) or liquids contained and/or dissolved in the pressure fluid can be removed by means of the cleansing routine. To this end, the valve assemblies 8, 10, 11, 16, 17, 18, 26, 27 are controlled in a certain, predeterminable chronological order to change from an open position into a closed position or vice-versa, so that a pressure fluid flow generated by the electronically driven pump 23 circulates through all branches of the pipeline system. The term ‘pipeline system’ herein has a most general implication and naturally includes bores, channels in component parts of a brake system, in particular channels in a hydraulic pressure control unit (so-called valve block) or the tandem master cylinder 2. During the cleansing routine the pressure fluid is pumped so-to-speak like in a circuit through the pipeline system at a high flow velocity. Removal of contaminants, e.g. due to degassing (gases) or by sedimentation (suspended matter), is executed downstream in the area of a quiet separating zone integrated into the pipeline system at a flow velocity that is reduced compared to the remaining pipeline system. It is self-explanatory that the electronic control of the cleansing routine also comprises the cleansing duration, cleansing pressure, or similar factors apart from process parameters such as the chronological systematics of actuation of the valve assemblies 8, 10, 11, 16, 17, 18, 26, 27.

In the switch position of the hydraulic fallback level, as can be seen from the FIGURE, the line portions 5, 12 as well as the master cylinder 2 are rinsed, with separating valves 8, 11 open and inlet valves 17, 18 closed, by introducing pressure fluid by way of the pressure source 20. For scavenging the other parts of the circuit, the separating valves are closed in a way comparable to the brake-by-wire mode, and the other valves 10, 16, 17, 18 are alternatingly actuated, with the outlet valves 26, 27 open, in such a manner that all parts of the circuit are cleansed.

Due to the electronic controllability of the valve assemblies 8, 10, 11, 16, 17, 18, 26, 27 and the pressure source 20, the cleansing routine is very flexible and can be performed as a separate, electronically controlled procedure step at principally any times desired. It is e.g. possible to execute the cleansing routine during driving operation, especially after driving start or briefly before driving is terminated, provided the brake system is not actuated. Further, it is feasible to execute the cleansing routine after termination of the driving operation, preferably immediately after parking of the vehicle or during a driving operation in specific driving situations (for example, during a braking pause after a great braking effort—driving downhill a pass), or if a separate method for detection of contaminants detects a need for removal thereof. In a variation of the invention it is possible to initiate the cleansing routine periodically or by means of a separate (software) switch, which may be done during vehicle maintenance, as the case may be. The electronic controllability of the valve assemblies 8, 10, 11, 16, 17, 18, 26, 27 further permits combinations of switch positions which render it possible to remove contaminants from pipeline areas that have no or only little fluid circulation in normal braking operations. When the method or the device for removal of contaminants is combined with a device for detection of contamination, the duration of the cleansing routine can be adjusted depending on the degree of contamination. More specifically, the cleansing routine can be performed until the desired degree of cleansing has been achieved.

It is cost-efficient when the means for removal of contaminants additionally includes a function as an absolutely necessary component of the brake system. For example, the pressure fluid reservoir can be provided with several cubicles, which reduce the flow velocity and into which the pressure fluid is conducted for degassing. More specifically, the separating zone can be integrated into the pressure fluid reservoir 4, and removal of contaminants is done by means of a defined actuation of necessary components of the brake system on the basis of a memorized software program being executed by means of the electronic control unit 31. Because purified pressure fluid is permanently aspirated out of the pressure fluid reservoir 4 and reintroduced into the circuit in the cleansing routine, the entire circuit volume is purified successively. Preferably, the separating zone (the pressure fluid reservoir) is arranged at the highest point of the hydraulic system—meaning the area of a natural pressure drain—where degassing particles gather.

The purification process may be supported by additional measures. When a means for heating the pressure fluid (heating device) is provided, this will enhance the degassing effort. As a heating device, e.g. a heated hose or a heated pipe according to DE 19901029 A1 may be provided, the disclosure of said application being included in the present application. A heating device in the range of a pressure control unit corresponding to DE 37 09 189 A1, DE 199 02 033 A1, and DE 199 171 A1 is also useful in the respect. It is of further assistance that the pressure fluid level in the pressure fluid reservoir is not exposed to the ambient atmosphere but to a pressure below atmospheric pressure or a vacuum. Accordingly, a means for the generation of said low pressure or vacuum may be provided. It may also be arranged for to improve the removal of contaminants by ultrasonic stimulation. Accordingly, ultrasonic generators may be mounted at locations of the pipeline system or in the area of the separating zone.

List of Reference Numerals:

1 actuating pedal

2 tandem master cylinder

3 simulator

4 pressure fluid reservoir

5 line

6 wheel brake

7 wheel brake

8 separating valve

9 line portion

10 pressure compensating valve

11 separating valve

12 line

13 wheel brake S₁ pressure sensor

14 wheel brake S₂ pressure sensor

15 line portion

16 pressure compensating valve

17 2/2 control valve

18 2/2 control valve

19

20 pressure source

21 high-pressure accumulator

22 electric motor

23 pump

24 pressure limiting valve

25 line

26 outlet valve

27 outlet valve

28 line

29 pressure sensor

30 pressure sensor

31 control unit

32 actuating travel sensor

33 wheel sensor

34 wheel sensor

1. Method for operating an electronically controllable brake actuation system for motor vehicles, including a non-pressurized pressure fluid supply reservoir (4), at least one pressure source (20) actuatable by an electronic control unit (31), whose pressure can be applied to wheel brakes (6, 7; 13, 14) of the vehicle, a device (2, 32, S₁) for detecting a driver's request for deceleration, as well as valve assemblies (8, 10, 11, 16, 17, 18, 26, 27) inserted upstream of the wheel brakes (6, 7; 13, 14) and connecting the wheel brakes (6, 7; 13, 14) optionally to the pressure source (20) or the pressure fluid reservoir (4) by way of a pipeline system,
characterized in that an electronically controlled procedure step is provided regarding the removal of contaminants contained and/or dissolved in the brake system, in particular in the pressure fluid, without separate assembling operations.

2. Method as claimed in claim 1,
characterized in that the procedure step is automated and/or can be performed on call.

3. Method as claimed in claim 1 or 2,
characterized in that a cleansing routine is provided for removal of the contaminants.

4. Method as claimed in any one or more of the preceding claims,
characterized in that for the cleansing routine valve assemblies (8, 10, 11, 16, 17, 18, 26, 27) are controlled according to a predefinable chronological order to change from an open position into a closed position and vice-versa.

5. Method as claimed in any one or more of the preceding claims,
characterized in that the removal during driving operation takes place constantly, or at predeterminable intervals, or in predeterminable situations, or upon request, and/or when the vehicle is stationary.

6. Method as claimed in any one or more of the preceding claims,
characterized in that the duration of the cleansing routine is adjusted in dependence on the degree of contamination of the pressure fluid.

7. Electronically controllable brake actuation system, in particular for implementing the method as claimed in any one or more of claims 1 to 6, including a non-pressurized pressure fluid supply reservoir (4), at least one pressure source (20) actuatable by an electronic control unit (31), whose pressure can be applied to wheel brakes (6, 7; 13, 14) of the vehicle, a device (2, 32, S₁ ) for detecting a driver's request for deceleration, as well as valve assemblies (8, 10, 11, 16, 17, 18, 26, 27) inserted upstream of the wheel brakes (6, 7; 13, 14) and connecting the wheel brakes (6, 7; 13, 14) optionally to the pressure source (20) or the pressure fluid reservoir (4) by way of a pipeline system,
characterized in that a means is provided for the electronically controlled removal of contaminants contained and/or dissolved in the brake system, in particular in the pressure fluid.

8. Electronically controllable brake actuation system as claimed in claim 7,
characterized in that the means for the removal of contaminants comprises an electronic control unit (31) with a memorized cleansing routine.

9. Electronically controllable brake actuation system as claimed in claim 6, 7 or 8,
characterized in that the means is an integral system component of the pipeline system.

10. Electronically controllable brake actuation system as claimed in any one or more of the preceding claims,
characterized in that an absolutely necessary component of the brake actuation system is additionally provided as a means for the removal of contaminants.

11. Electronically controllable brake actuation system as claimed in any one or more of the preceding claims,
characterized in that pipeline portions with a high flow velocity of the pressure fluid are provided and following downstream thereof is at least one separating zone with a pressure fluid flow velocity lower in comparison.

12. Electronically controllable brake actuation system as claimed in any one or more of the preceding claims,
characterized in that the separating zone is provided in the pressure fluid reservoir (4).

13. Electronically controllable brake actuation system as claimed in any one or more of the preceding claims,
characterized in that at least one means for heating the pressure fluid is arranged for.

14. Electronically controllable brake actuation system as claimed in any one or more of the preceding claims,
characterized in that the separating zone is disposed in the range of a pressure drain.

15. Electronically controllable brake actuation system as claimed in any one or more of the preceding claims,
characterized in that associated with the separating zone is a means for the generation of pressure below atmospheric pressure and/or vacuum.

16. Electronically controllable brake actuation system as claimed in any one or more of the preceding claims,
characterized in that a system component, in particular the separating zone, is equipped with an ultrasonic generator to generate ultrasonic vibrations in the pressure fluid.
